(19) United States
(12) Patent Application Publication
(10) Pub. No.: US 2018/0245535 A1
(43) Pub. Date: Aug. 30, 2018

(54) METHOD FOR ASCERTAINING A CAUSE OF A FAULT IN AN INJECTION SYSTEM OF AN INTERNAL COMBUSTION ENGINE

(71) Applicant: Robert Bosch GmbH, Stuttgart (DE)

(72) Inventors: Claus Wundling, Freiberg (DE); Rainer Ecker, Kornwestheim (DE); Thomas Kuhn, Heibronn (DE); Timm Hollmann, Benningen A.n. (DE); Udo Schulz, Vaihingen/Enz (DE)

(21) Appl. No.: 15/758,002

(22) PCT Filed: Aug. 2, 2016
(86) PCT No.: PCT/EP2016/068406

§ 371 Date: Mar. 7, 2018

(30) Foreign Application Priority Data
Sep. 8, 2015 (DE) 10 2015 217 138.8

(51) Int. Cl. F02D 41/22; F02D 41/30; F02D 41/14; F02D 35/02

(52) U.S. Cl. CPC F02D 41/221; F02D 41/3094; F02D 2200/101; F02D 35/023; F02D 41/1454

(57) ABSTRACT

A method for ascertaining a cause of an fault in an injection system of an internal combustion engine having manifold and direct injections as injection types includes, if a fault exists in at least one first combustion process in an injection system associated with a combustion chamber of the internal combustion engine, replacing a first of the two injection types used in the at least one first combustion process with a second of the two injection types in at least one second combustion process, and, identifying the first injection type as the cause responsive to the fault no longer being detected in the second combustion process.

### CROSS-REFERENCE TO RELATED APPLICATIONS

The present application is the national stage of International Pat. App. No. PCT/EP2016/068406 filed Aug. 2, 2016, and claims priority under 35 U.S.C. § 119 to DE 10 2015 217 138.8, filed in the Federal Republic of Germany on Sep. 8, 2015, the content of each of which are incorporated herein by reference in their entireties.

### FIELD OF THE INVENTION

The present invention relates to a method for ascertaining a cause of a fault in an injection system of an internal combustion engine having manifold injection and direct injection as well as to a processing unit and a computer program for its implementation.

### BACKGROUND

A possible method for fuel injection in spark-ignition engines is the manifold injection, which is increasingly replaced by a direct injection of fuel. The latter method results in markedly improved fuel distribution in the combustion chambers and thus results in improved output yield at lower fuel consumption.

Furthermore, there also exist spark-ignition engines having a combination of manifold injection and direct injection, a so-called dual system. This is advantageous especially in light of ever more stringent emission requirements or emission limit values, since for example in medium load ranges the manifold injection results in better emission values than a direct injection. In full load ranges, by contrast, the direct injection allows for example for a reduction in so-called engine knock. Here, a cooling effect produced by fuel evaporation in the combustion chamber allows for an advanced ignition angle, which allows for higher output and/or lower consumption.

### SUMMARY

It is possible for faults to occur in a combustion process, which are caused by the injection system.

The present invention provides a method for ascertaining a cause of a fault in an injection system of an internal combustion engine as well as a processing unit and a computer program for its implementation.

According to an example embodiment of the present invention, a method ascertains a cause of a fault in an injection system of an internal combustion engine having manifold injection and direct injection as injection types. To this end, if a fault occurs in an injection system associated with a combustion chamber of the internal combustion engine in at least one first combustion process, a first of the two injection types used in the at least one first combustion process is replaced in at least a second combustion process by a second of the two injection types. Then, if the fault is no longer detected in the at least one second combustion process, the cause of the fault is attributed to the first injection type. Such a fault can be for example that a fuel quantity introduced into the combustion chamber is too low or too high, which means in particular an undesired air-fuel ratio in the combustion chamber and can result in ignition failures for example.

For this purpose, the present invention makes use of the dual system, i.e., an internal combustion engine having both manifold injection as well as direct injection, which is able to introduce fuel into the combustion chamber in two different manners. Now, if in a combustion process a fault is detected in the injection system, then it is possible to change the injection type in a later combustion process. For example, if pure direct injection is used and a fault is detected, then it is possible to use pure manifold injection in the later combustion process. If the fault is then no longer detected, it can be assumed that the cause of the fault lies in the direct injection. In the same way, it is possible to switch from pure direct injection to pure manifold injection. In this manner, a cause of a detected fault can be attributed very simply to the injection type. Naturally, such a method can be performed for each combustion chamber or cylinder of the internal combustion engine. In particular, this allows for a cylinder-specific or injector-specific fault attribution.

Preferably, if the fault continues to be detected in the at least one second combustion process and if in the at least one first combustion process both injection types were used, then the second injection type is replaced in at least one third combustion process by the first injection type, and, if in the at least one third combustion process the fault is no longer detected, then the cause of the fault is attributed to the second injection type. In the event that the fault is detected when both injection types are used simultaneously, independently of the precise distribution of the fuel quantity to be introduced between the two injection types, it can happen that the cause of the fault cannot be attributed in the first step. If, for example, in a uniform distribution of the fuel quantity between the two injection types, a switch is made in a later combustion process to pure manifold injection, i.e., the fuel previously introduced by direct injection is then introduced by manifold injection, then it can happen that the fault continues to occur. The reason for this could be that the fault lies in the manifold injection. If therefore, in a further combustion process, a switch is made to pure direct injection, then the cause of the fault can be attributed to the manifold injection if the fault is then no longer detected. This thus allows for a simple attribution of the cause of a detected fault even in the simultaneous use of both injection types.

It is advantageous if the fault is detected on the basis of a deviation of at least one combustion-dependent variable, which includes a rotational speed, a combustion chamber pressure, and/or a lambda value in the exhaust gas, from a respective comparison value. An insufficient fuel quantity results in a lower pressure in the combustion chamber and thus in a lower force being exerted on the piston in the combustion chamber during the combustion. This in turn results in a changed torque through the respective combustion chamber, which becomes noticeable in a changed rotational speed. In the process, in particular a rotational speed fluctuation as seen over a rotation of the crankshaft can turn out to be different than in regular operation. It is possible to ascertain an insufficient fuel quantity in the exhaust gas via a changed lambda value. It is thus possible to ascertain a fault in a very simple manner using means that normally exist anyway such as a rotational speed meter, a combustion chamber sensor, and a lambda probe.

The respective comparison value expediently includes an average value of the associated combustion-dependent variable over multiple, in particular all, combustion chambers of the internal combustion engine or a specifiable setpoint value. It is very easy to perform a relative comparison when using the average value. It is then possible to neglect possible systemic measuring errors, which occur in all combustion chambers. When using a setpoint value such as can be ascertained on the basis of test measurements for example, it is possible to detect faults very precisely.

Preferably, when the cause of the fault has been attributed, the injection type, to which the fault was assigned, is used for a confirmation of the fault in at least one fourth combustion process. In this manner, it is possible to achieve greater reliability or diagnosis robustness regarding the actual cause of the fault, in that the supposed fault-causing injection type is checked once again. This is often also referred to as a so-called fault debounce, in which for example sporadic faults, for example due to signal interferences, may be excluded.

Advantageously, when the cause of the fault has been attributed, only the injection type, to which the fault was not attributed, is used for the further operation of the internal combustion engine. This makes it possible in a simple manner to avoid further faults in the further operation and especially also bad emission values. Furthermore, it is then also possible for example to store the detected cause in a fault memory or the like.

If the cause of the fault was not attributed and the fault continues to be detected, and if no check of an ignition device of the combustion chamber is performed, the cause of the fault is preferably attributed to the ignition device. If the injection systems are ruled out as the cause, then the next most probably cause is normally the ignition device, in particular a spark plug. If no separate check of the ignition device is performed, it is possible very simply to draw the inference that the ignition device is the cause of the fault.

If the cause of the fault was not attributed and the fault continues to be detected, and if a check of an ignition device of the combustion chamber is performed, and if the cause of the fault was not attributed to the ignition device, the cause of the fault is advantageously attributed to an air supply for the combustion chamber. If a separate check of the ignition device is performed, for example by an electrical check of the contacts of the spark plug and/or of the resistance of the spark plug, then the next most probably cause is normally the air supply, in particular an air-mass flow sensor in the induction manifold. This thus allows for a very simple ascertainment of the cause of the fault.

A processing unit according to the present invention, e.g., a control unit, particularly an engine control unit of a motor vehicle, is designed, particularly in terms of program technology, to carry out a method according to the present invention.

The implementation of the method in the form of a computer program is also advantageous, since this entails particularly low costs, in particular if an executing control unit is also used for other tasks and is therefore present anyway. Suitable data carriers for providing the computer program are in particular magnetic, optical and electrical memories such as e.g., hard disks, flash memories, EEPROMS, DVDs etc. A download of a program via computer networks (Internet, intranet, etc.) is also possible.

Additional advantages and developments of the present invention derive from the description and the enclosed drawings, which schematically illustrate the present invention in connection with an example embodiment and which are described below.

### BRIEF DESCRIPTION OF THE DRAWINGS

FIGS. 1a and 1b schematically show two internal combustion engines for which a method is performed according to an example embodiment of the present invention.

FIG. 2 schematically shows a cylinder of an internal combustion engine for which a method is performed according to an example embodiment of the present invention.

FIG. 3 is a flowchart that illustrates a method according to an example embodiment of the present invention.

FIG. 4 is a flowchart that illustrates a method according to another example embodiment of the present invention.

### DETAILED DESCRIPTION

Figure la shows schematically and in simplified fashion an internal combustion engine 100, which can be used for a method according to an example embodiment of the present invention. By way of example, internal combustion engine 100 has four combustion chambers 103 and an induction manifold 106, which is connected to each of the combustion chambers 103.

Induction manifold 106 has a fuel injector 107 for each combustion chamber, which is situated in the respective section of the induction manifold just before the combustion chamber. Fuel injectors 107 are thus used for manifold injection. Each combustion chamber 103 furthermore has a fuel injector 111 for direct injection.

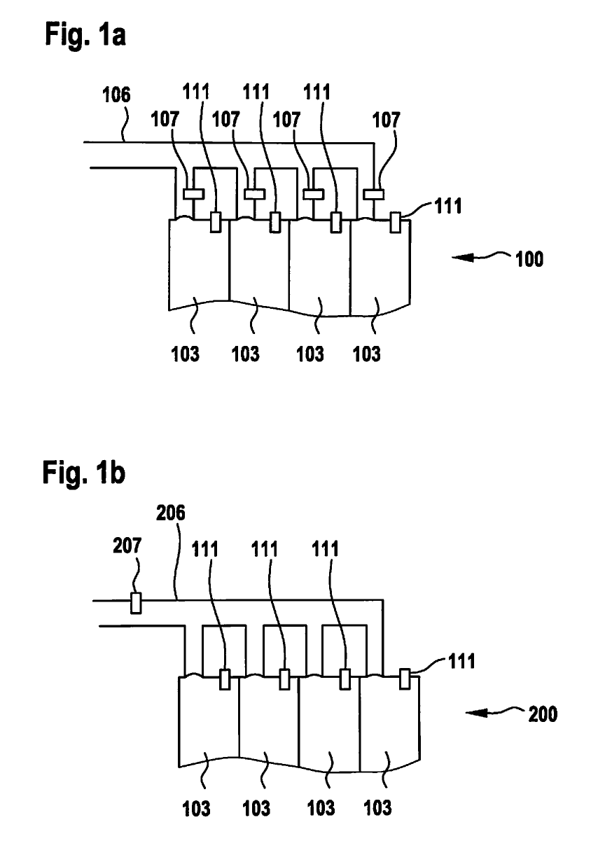

FIG. 1b shows schematically and in simplified fashion another internal combustion engine 200, which can be used for a method according to an example embodiment of the present invention. By way of example, internal combustion engine 100 has four combustion chambers 103 and an induction manifold 206, which is connected to each of the combustion chambers 103.

Induction manifold 206 has in this case one common fuel injector 207 for all combustion chambers 103, which is situated in the induction manifold for example just after a throttle valve that is not shown here. The first fuel injector 107 is thus used for manifold injection. Each combustion chamber 103 furthermore has a fuel injector 111 for direct injection.

Both fuel injectors 100 and 200 thus have a so-called dual system, i.e., manifold injection and direct injection. The difference is merely in the type of manifold injection. For example, while the manifold injection shown in FIG. 1a allows for individual fuel metering for each combustion chamber, as can be used for example for higher quality internal combustion engines, the manifold injection shown in FIG. 1b is simpler in its construction and in the way it is controlled. The two internal combustion engines shown can be in particular spark-ignition engines.

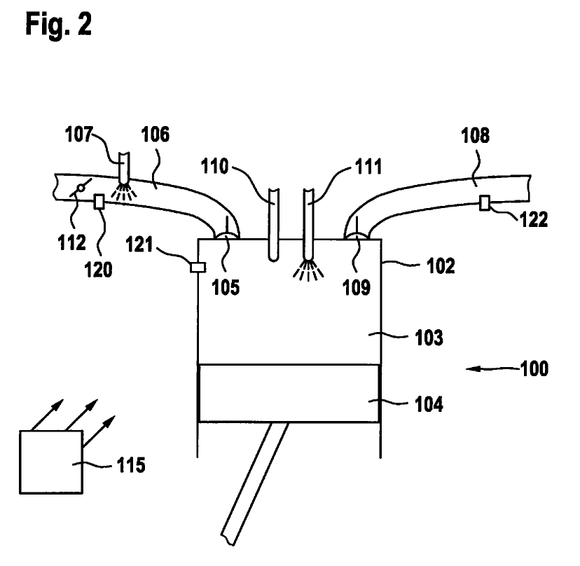

FIG. 2 shows a cylinder 102 of internal combustion engine 100 schematically and in simplified fashion, although in more detail than in Figure la. Cylinder 102 has a combustion chamber 103, which is enlarged and reduced by the movement of a piston 104. The present internal combustion engine can be in particular a spark-ignition engine.

Cylinder 102 has an intake valve 105 in order to take in air or a fuel-air mixture into combustion chamber 103. The air is supplied via induction manifold 106 as part of an air supply, on which fuel injector 107 is located. Inducted air is taken into combustion chamber 103 of cylinder 102 via intake valve 105. A throttle valve 112 in the air supply system is used to adjust the required air-mass flow into cylinder 102. An air-mass flow sensor 120 is provided in induction manifold 106, which is able to ascertain the quantity of air introduced into the combustion chamber.

The internal combustion engine can be operated in the course of a manifold injection. In the course of this manifold injection, fuel is injected into induction manifold 106 with the aid of fuel injector 107 so that an air-fuel mixture forms there, which enters combustion chamber 103 of cylinder 102 via intake valve 105. A combustion chamber pressure sensor 121 is provided for ascertaining a pressure in combustion chamber 103.

The internal combustion engine can also be operated in the course of a direct injection. For this purpose, fuel injector 111 is attached on cylinder 102 in order to inject fuel directly into combustion chamber 103. In this direct injection, the air-fuel mixture required for combustion is formed directly in the combustion chamber 103 of cylinder 102.

Cylinder 102 is furthermore provided with an ignition device 110 in order to produce an ignition spark for starting a combustion in combustion chamber 103.

Following a combustion, combustion exhaust gases are discharged from cylinder 102 via an exhaust pipe 108. The discharge occurs as a function of the opening of a discharge valve 109, which is likewise situated on cylinder 102. Intake and discharge valves 105, 109 are opened and closed in order to perform a four-stroke operation of internal combustion engine 100 in the known manner. A lambda probe 122 is provided in exhaust pipe 108, which is able to ascertain a residual oxygen content in the exhaust gas, from which in turn it is possible to infer an air-fuel ratio in the combustion engine.

It is possible to operate internal combustion engine 100 using direct injection, manifold injection or in a mixed operating mode. This makes it possible to select in each case the optimum operating mode for operating internal combustion engine 100 as a function of the current operating point. Thus it is possible, for example, to operate internal combustion engine 100 in a manifold injection operation when it is operated at low rotational speed and at low load, and to operate it in a direct injection operation when it is operated at high rotational speed and high load. Over a great operating range, however, it is expedient to operate internal combustion engine 100 in a mixed operating mode, in which the fuel quantity to be supplied to combustion chamber 103 is supplied in part by manifold injection and in part by direct injection.

Furthermore, a processing unit designed as a control unit 115 is provided for controlling internal combustion engine 100. Control unit 115 is able to operate internal combustion engine 100 in direct injection, manifold injection or in the mixed operating mode. Control unit 115 is furthermore also able to detect measured values from air-mass flow sensor 120, from combustion chamber pressure sensor 121 and from lambda probe 122.

It is possible to apply the functioning of internal combustion engine 100 explained in more detail with reference to FIG. 2 also to internal combustion engine 200 as shown in FIG. 1b, but with the difference that only one common fuel injector is provided for all combustion chambers or cylinders. In manifold injection or in a mixed operating mode, the sole fuel injector in the induction manifold is thus used for all cylinders.

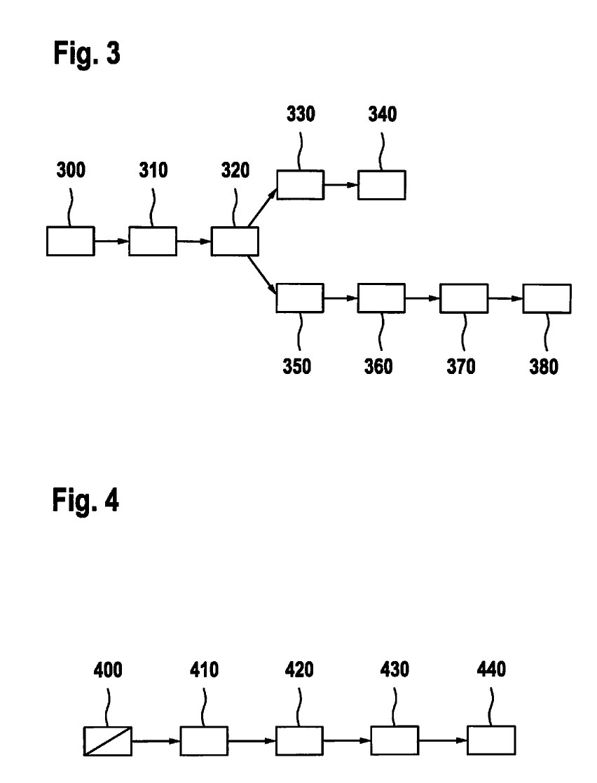

FIG. 3 illustrates a method of the present invention according to an example embodiment. First, in a step 300, the internal combustion engine can be in regular operation, in this instance for example by pure direct injection.

In a step 310, it is now possible to detect a fault in the injection system of a combustion chamber of the internal combustion engine. The fault can be an ignition failure for example. This can be detected on the basis of a combustion-dependent variable, for example on the basis of a deviation of the lambda value in the exhaust gas ascertained by the lambda probe, a pressure deviation in the combustion chamber ascertained by the combustion chamber pressure sensor, and/or rotational speed variations.

In a step 320, it is now possible to switch the operation of the internal combustion engine for the respective combustion chamber, or optionally also for all combustion chambers, to pure manifold injection. If now in a step 330 a check is performed anew for the fault and the fault is no longer detected, then it is possible to attribute the cause of the fault to the direct injection.

Subsequently, according to a step 330, the further operation of the internal combustion engine for the respective combustion chamber, or optionally also for all combustion chambers, can be continued by pure manifold injection.

If, in the alternative to step 330, a check for the fault is performed anew, in accordance with a step 350, and the fault continues to be detected, then is must be assumed that the direct injection is not the cause of the fault. A simultaneous fault in the direct injection and in the manifold injection is highly improbable and may therefore be neglected.

In a step 360, a switch back to direct injection may be performed for the further operation of the internal combustion engine, since no cause of the fault is seen there. In a step 370, it is now possible to check the ignition device as well. If the cause of the fault is excluded there as well, then, in a step 380, the cause of the fault may be attributed to the air supply, in particular to the air-mass flow sensor.

FIG. 4 illustrates a method of the present invention according to another example embodiment. In a step 400, the internal combustion engine can be in regular operation, in this instance for example by direct injection and manifold injection. The distribution between direct injection and manifold injection can occur in equal parts.

In a step 410, it is now possible to detect a fault in the injection system of a combustion chamber of the internal combustion engine. The fault can be an ignition failure for example. This can be detected on the basis of a combustion-dependent variable, for example on the basis of a deviation of the lambda value in the exhaust gas ascertained by the lambda probe, a pressure deviation in the combustion chamber ascertained by the combustion chamber pressure sensor, and/or rotational speed variations.

In a step 420, it is now possible to switch the operation of the internal combustion engine for the respective combustion chamber, or optionally also for all combustion chambers, to pure manifold injection. This means that the fuel quantity introduced into the combustion chamber by manifold injection in accordance with regular operation continues to be introduced by manifold injection. The fuel quantity introduced into the combustion chamber by direct injection according to regular operation will now, however, be introduced also by manifold injection.

If now in a step 430 a check for the fault is performed anew and the fault continues to be detected, it is not yet possible to attribute the cause of the fault unequivocally. For this reason, it is possible to switch to pure direct injection in a step 440. This means that the fuel quantity introduced into the combustion chamber by direct injection in accordance with regular operation also continues to be introduced by direct injection. The fuel quantity introduced into the combustion chamber by manifold injection in accordance with regular operation will now, however, be introduced also by direct injection.

This is now sufficient in order to be able to decide whether one of the injection types, and, if so, which one, is the cause of the fault. On this basis it is now possible to continue for example as in FIG. 3 with step 320.

1-11. (canceled)

12. A method for performing a control based on a cause of a fault in an internal combustion engine injection system that provides a first injection type and a second injection type for injections into a combustion chamber, the method comprising:
responsive to occurrence of the fault during a first combustion process in which the first injection type is used, using, by a control unit, the second injection type in a second combustion process;
identifying, by the control unit, the first injection type as the cause of the fault responsive to a determination that the fault is not detected during the second combustion process; and
controlling, by the control unit, further injections based on the identification;
wherein one of the first and second injection types is a manifold injection and the other of the first and second injection types is a direct injection.

13. The method of claim 12, wherein the fault is detected based on a deviation of at least one combustion-dependent variable from a respective comparison value, the at least one combustion-dependent variable including a rotational speed, a combustion chamber pressure, and an exhaust gas lambda value.

14. The method of claim 13, wherein the comparison value is a predefined setpoint value.

15. The method of claim 12, wherein the fault is detected based on a deviation of at least one combustion-dependent variable from an average of a respective comparison value over a plurality of combustion chambers, the at least one combustion-dependent variable including a rotational speed, a combustion chamber pressure, and an exhaust gas lambda value.

16. The method of claim 12, further comprising, subsequent to the identifying, using the first injection type in a third combustion process to confirm the first injection type as the cause of the fault.

17. The method of claim 12, wherein, responsive to the identification of the first injection type as the cause of the fault, only the second injection type is used for a further combustion process.

18. The method of claim 12, wherein the method is performed executing a process that defines that if the cause of the fault is not attributed to either of the first and second injection types, the fault continues to be detected, and no check of an ignition device of the combustion chamber is performed, the cause of the fault is attributed to the ignition device.

19. The method of claim 12, wherein the method is performed executing a process that defines that if the cause of the fault is not attributed to either of the first and second injection types, the fault continues to be detected, and a check of an ignition device of the combustion chamber that the ignition device is not the cause of the fault, the cause of the fault is attributed to an air supply for the combustion chamber.

20. A method for performing a control based on a cause of a fault in an internal combustion engine injection system that provides a first injection type and a second injection type for injections into a combustion chamber, the method comprising:
responsive to occurrence of the fault during a first combustion process in which the first and second injection types are used, using, by a control unit, only the first injection type in a second combustion process;
determining, by the control unit, that the fault continued to occur during the second combustion process;
responsive to the determination of the continued occurrence of the fault during the second combustion process, using, by the control unit, only the second injection type in a third combustion process;
identifying, by the control unit, the first injection type as the cause of the fault responsive to a determination that the fault is not detected during the third combustion process; and
controlling, by the control unit, further injections based on the identification;
wherein one of the first and second injection types is a manifold injection and the other of the first and second injection types is a direct injection.

21. A processing unit comprising:
circuitry by which injectors of a combustion chamber of an internal combustion engine injection system are controllable, wherein:
one of the first and second injection types is a manifold injection and the other of the first and second injection types is a direct injection;
the injection system provides a first injection type and a second injection type for injections into the combustion chamber; and
the circuitry is configured to perform a method for ascertaining a cause of a fault in the injection system, the method comprising:
responsive to occurrence of the fault during a first combustion process in which the first injection type is used, controlling the injectors to use the second injection type in a second combustion process;
identifying the first injection type as the cause of the fault responsive to a determination that the fault is not detected during the second combustion process; and
controlling further injections based on the identification.

22. A non-transitory computer-readable medium on which are stored instructions that are executable by a processor and that, when executed by the processor, cause the processor to perform a method for ascertaining a cause of a fault in an internal combustion engine injection system that provides a first injection type and a second injection type for injections into a combustion chamber, the method comprising:
responsive to occurrence of the fault during a first combustion process in which the first injection type is used, using the second injection type in a second combustion process; and
identifying the first injection type as the cause of the fault responsive to a determination that the fault is not detected during the second combustion process; and
controlling further injections based on the identification;
wherein one of the first and second injection types is a manifold injection and the other of the first and second injection types is a direct injection.
